(19) United States
(12) Patent Application Publication
(10) Pub. No.: US 2022/0169899 A1
(43) Pub. Date: Jun. 2, 2022

(54) Polymers For Bonding Coral

(71) Applicant: Mussel Polymers, Inc., Bethlehem, PA (US)

(72) Inventors: Adam Gregg Malofsky, Loveland, OH (US); Bernard Miles Malofsky, Bloomfield, CT (US); Jason Andrew Stieg, Lafayette Hill, PA (US); David Schmidt, Chester, NJ (US); Eric Anderson, Princeton, NJ (US)

(21) Appl. No.: 17/486,496

(22) Filed: Sep. 27, 2021

Related U.S. Application Data
(60) Provisional application No. 63/083,896, filed on Sep. 26, 2020.

(51) Int. Cl. C09J 125/18; C09J 7/28; C09J 7/20; C09J 7/32

(52) U.S. Cl. CPC C09J 125/18; C09J 7/28; C09J 2400/163; C09J 7/32; C09J 2425/00; C09J 7/20

(57) ABSTRACT

The disclosure relates to a thin layer comprising a catechol containing polymer or oligomer, as well as methods of making and using the thin layer comprising the catechol containing polymer or oligomer. The disclosure also relates to a thin layer comprising a catechol containing polymer or oligomer adjacent to and in contact with a bulk adhesive layer. The layers demonstrate improved adhesion between coral and coral-like materials.

### CROSS REFERENCE TO RELATED APPLICATIONS

This application claims the benefit of U.S. Provisional Application No. 63/083,896, filed Sep. 26, 2020, the entirety of which is incorporated by reference herein.

### TECHNICAL FIELD

The present disclosure relates to thin layers comprising catechol containing polymer or oligomer, which demonstrate improved adhesion between coral or coral-like materials. The present disclosure also relates to methods of making and using the thin layers of catechol containing polymer or oligomer for bonding coral or coral-like materials.

### BACKGROUND

Current methods for attaching or bonding coral and similar aquatic organisms is fraught with challenges that make productive attachment difficult. Such challenges include potential toxicity to coral and surrounding environments, difficulty in applying materials in aqueous environments, and a lack of durable, long-lasting material for the attaching or bonding. For instance, cyanoacrylates bond almost instantly, but these materials have poor water resistance and are brittle, which eventually leads to failure. Epoxies are another type of prominent adhesive, but epoxies are typically two-part mixtures with short pot lives and have proven challenging to apply in aqueous environments.

There thus exists a need for materials that can attach or bond coral and similar aquatic organisms, whereby the materials also minimize, if not eliminate, the aforementioned challenges.

### SUMMARY OF THE INVENTION

The present disclosure is directed to a polymeric layer comprising a catechol containing polymer or oligomer, wherein said catechol presents as a catechol and/or as a semi-quinone and/or as a quinone without the presence of a primary amine or a secondary amine; and wherein the polymeric layer optionally comprises a reactive material that is not reactive with catechol or quinone. The present disclosure is also directed to a polymeric layer comprising a catechol containing polymer or oligomer disposed adjacent to and in contact with a bulk adhesive layer. The present disclosure is also directed to methods of making and using the layers described herein.

### BRIEF DESCRIPTION OF THE DRAWINGS

FIG. 1 depicts a schematic of an embodiment of the layers and layered articles described herein.

FIG. 2 depicts a schematic of another embodiment of the layers and layered articles described herein.

### DETAILED DESCRIPTION OF ILLUSTRATIVE EMBODIMENTS

In the present disclosure the singular forms “a”, “an,” and “the” include the plural reference, and reference to a particular numerical value includes at least that particular value, unless the context clearly indicates otherwise. Thus, for example, a reference to “a material” is a reference to at least one of such materials and equivalents thereof known to those skilled in the art, and so forth.

When a value is expressed as an approximation by use of the descriptor “about” or “substantially” it will be understood that the particular value forms another embodiment. In general, use of the term “about” or “substantially” indicates approximations that can vary depending on the desired properties sought to be obtained by the disclosed subject matter and is to be interpreted in the specific context in which it is used, based on its function. The person skilled in the art will be able to interpret this as a matter of routine. In some cases, the number of significant figures used for a particular value may be one non-limiting method of determining the extent of the word “about” or “substantially”. In other cases, the gradations used in a series of values may be used to determine the intended range available to the term “about” or “substantially” for each value. Where present, all ranges are inclusive and combinable. That is, references to values stated in ranges include every value within that range.

When a list is presented, unless stated otherwise, it is to be understood that each individual element of that list and every combination of that list is to be interpreted as a separate embodiment. For example, a list of embodiments presented as “A, B, or C” is to be interpreted as including the embodiments, “A,” “B,” “C,” “A or B,” “A or C,” “B or C,” or “A, B, or C.”

It is to be appreciated that certain features of the disclosure which are, for clarity, described herein in the context of separate embodiments, may also be provided in combination in a single embodiment. That is, unless obviously incompatible or excluded, each individual embodiment is deemed to be combinable with any other embodiments and such a combination is considered to be another embodiment. Conversely, various features of the disclosure that are, for brevity, described in the context of a single embodiment, may also be provided separately or in any sub-combination. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Finally, while an embodiment may be described as part of a series of steps or part of a more general structure, each said step may also be considered an independent embodiment in itself

In an aspect, the disclosure is directed to a polymeric layer comprising a catechol containing polymer or oligomer, wherein said catechol presents as a catechol and/or as a semi-quinone and/or as a quinone without the presence of a primary amine or a secondary amine; and wherein the polymeric layer optionally comprises a reactive material that is not reactive with catechol or quinone.

In an aspect, the disclosure is directed to a polymeric layer comprising a catechol containing polymer or oligomer, wherein said catechol presents as a catechol and/or as a semi-quinone and/or as a quinone without the presence of a primary amine or a secondary amine; and wherein the polymeric layer also comprises a reactive material that is not reactive with catechol or quinone.

In an aspect, the disclosure is directed to a polymeric layer comprising a catechol containing polymer or oligomer, wherein said catechol presents as a catechol and/or as a semi-quinone and/or as a quinone without the presence of a primary amine or a secondary amine; and wherein the polymeric layer optionally comprises a reactive material that is not reactive with catechol or quinone; and wherein the polymeric layer further comprises a bulk adhesive layer disposed adjacent to and in contact with the polymeric layer.

In an aspect, the disclosure is directed to a polymeric layer comprising a catechol containing polymer or oligomer, wherein said catechol presents as a catechol and/or as a semi-quinone and/or as a quinone without the presence of a primary amine or a secondary amine; and wherein the polymeric layer also comprises a reactive material that is not reactive with catechol or quinone; and wherein the polymeric layer further comprises a bulk adhesive layer disposed adjacent to and in contact with the polymeric layer.

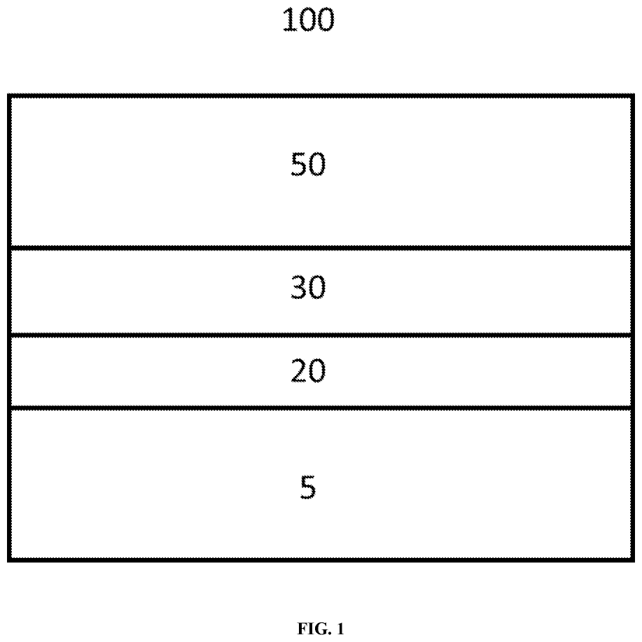

FIG. 1 depicts a general schematic of an embodiment of the polymeric layer 20 comprising the catechol containing polymer or oligomer and a layered article 100 comprising the polymeric layer 20 described herein. The layered article 100 may comprise a substrate 5 which the polymeric layer 20 is disposed on and in contact with. The layered article 100 may also comprise a bulk adhesive layer 30 disposed on the polymeric layer 20 and in contact with the polymeric layer 20. The layered article 100 may also comprise a second substrate 50 disposed on and in contact with bulk adhesive layer 30.

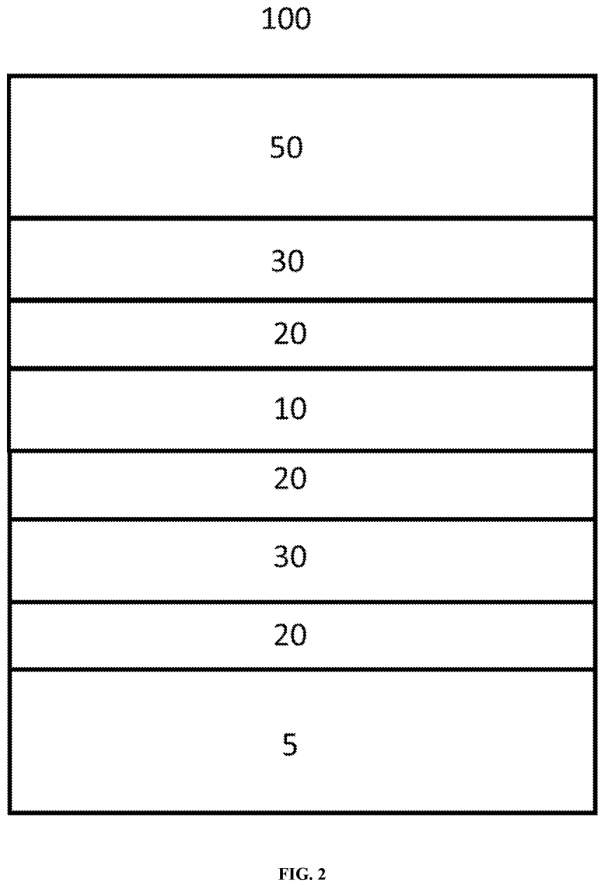

FIG. 2 depicts a general schematic of another embodiment of the polymeric layer 20 comprising the catechol containing polymer or oligomer and a layered article 100 comprising the polymer layer described herein. The layered article 100 may comprise a substrate 5 which the polymeric layer 20 is disposed on and in contact with. The layered article 100 may also comprise a bulk adhesive layer 30 disposed on the polymeric layer 20 and in contact with the polymeric layer 20. The layered article 100 may also comprise a second polymeric layer 20 disposed on and in contact with bulk adhesive layer 30. The layered article 100 may also comprise a tile 10 disposed on and in contact with the second polymeric layer 20. The layered article 100 may also comprise a third polymeric layer 20 disposed on and in contact with tile 10. The layered article 100 may also comprise a second bulk adhesive layer 30 disposed on and in contact with the third polymeric layer 20. The layered article 100 may also comprise a second substrate 50 disposed on and in contact with the second bulk adhesive layer 30.

In some embodiments, the catechol containing polymer or oligomer in the polymeric layer 20 is oligomeric. In some embodiments, the catechol containing polymer or oligomer in the polymeric layer 20 is polymeric.

In an aspect, the polymeric layer 20 has a thickness of from about 10 nanometers to about 100 microns. In some embodiments, the polymeric layer 20 has a thickness of from about 15 nanometers to about 50 microns. In some embodiments, the polymeric layer 20 has a thickness of from about 15 nanometers to about 15 microns. In some embodiments, the polymeric layer 20 has a thickness of from about 150 nanometers to less than about 15 microns. In some embodiments, the polymeric layer 20 has a thickness of from about 150 nanometers to about 1.5 microns.

In some embodiments, the polymeric layer 20 has a thickness of from about 10 nanometers to about 100 microns; or from about 10 nanometers to about 100 nanometers; or from about 100 nanometers to about 150 nanometers; or from about 150 nanometers to about 200 nanometers; or from about 200 nanometers to about 250 nanometers; or from about 250 nanometers to about 300 nanometers; or from about 300 nanometers to about 350 nanometers; or from about 350 nanometers to about 400 nanometers; or from about 400 nanometers to about 450 nanometers; or from about 450 nanometers to about 500 nanometers; or from about 500 nanometers to about 550 nanometers; or from about 550 nanometers to about 600 nanometers; or from about 600 nanometers to about 650 nanometers; or from about 650 nanometers to about 700 nanometers; or from about 700 nanometers to about 750 nanometers; or from about 750 nanometers to about 800 nanometers; or from about 800 nanometers to about 850 nanometers; or from about 850 nanometers to about 900 nanometers; or from about 900 nanometers to about 950 nanometers; or from about 950 nanometers to about 1000 nanometers.

In some embodiments, the polymeric layer 20 has a thickness of from about 1 micron to about 1.5 microns; or from about 1.5 microns to about 5 microns; or from about 5 microns to about 10 microns; or from about 10 microns to about 15 microns; or from about 15 microns to about 20 microns; or from about 20 microns to about 25 microns; or from about 25 microns to about 30 microns; or from about 30 microns to about 35 microns; or from about 35 microns to about 40 microns; or from about 40 microns to about 45 microns; or from about 45 microns to about 50 microns; or from about 50 microns to about 55 microns; or from about 55 microns to about 60 microns; or from about 60 microns to about 65 microns; or from about 65 microns to about 70 microns; or from about 70 microns to about 75 microns; or from about 75 microns to about 80 microns; or from about 80 microns to about 85 microns; or from about 85 microns to about 90 microns; or from about 90 microns to about 95 microns; or from about 95 microns to about 100 microns.

In an aspect, the catechol containing polymer or oligomer in the polymeric layer 20 comprises poly-catechol styrene (PCS).

In some embodiments, the PCS comprises from about 15% catechol to about 50% catechol. In some embodiments, the PCS comprises from about 20% catechol to about 40% catechol. In some embodiments, the PCS comprises from about 25% catechol to about 35% catechol. In some embodiments, the PCS comprises about 25% catechol. In some embodiments, the PCS comprises about 35% catechol.

In some embodiments, the PCS comprises from about 20% catechol to about 22% catechol; or from about 22% catechol to about 24% catechol; or from about 24% catechol to about 26% catechol; or from about 26% catechol to about 28% catechol; or from about 28% catechol to about 30% catechol; or from about 30% catechol to about 32% catechol; or from about 32% catechol to about 34% catechol; or from about 34% catechol to about 36% catechol; or from about 36% catechol to about 38% catechol; or from about 38% catechol to about 40% catechol.

In some embodiments, the polymeric layer comprises the reactive material that is not reactive with catechol or quinone. In some embodiments, the reactive material is not reactive at ambient temperature with catechol or quinone. In some embodiments, the reactive material is not reactive at low temperature with catechol or quinone.

In some embodiments, the reactive material that is not reactive with catechol or quinone is a resin, an oligomer, a polymer or a monomer. In some embodiments, the reactive material an oligomer. In some embodiments, the reactive material a polymer. In some embodiments, the reactive material a monomer. In some embodiments, the reactive material is a urethane or a urethane component.

In an aspect, the polymeric layer 20 is a continuous layer. In an aspect, the polymeric layer 20 is a non-continuous layer. In an aspect, the polymeric layer 20 is a patterned layer or a textured layer.

In an aspect, the bulk adhesive layer 30 comprises urethane or a urethane component or a catechol containing oligomer or polymer. In some embodiments, the urethane or a urethane component comprises methylene diphenyl diisocyanate (MDI) resins. In some embodiments, the bulk adhesive layer 30 comprises methylene diphenyl diisocyanate (MDI) resins. In some embodiments, the bulk adhesive layer 30 comprises catechol containing oligomer or polymer. In some embodiments, the catechol containing oligomer or polymer comprises polycatechol styrene (PCS).

In some embodiments, the bulk adhesive layer 30 further comprises calcium carbonate, silica, nevex resin, or combinations thereof. In some embodiments, the bulk adhesive layer 30 further comprises calcium carbonate. In some embodiments, the bulk adhesive layer 30 further comprises silica. In some embodiments, the bulk adhesive layer 30 further comprises nevex resin.

In an aspect, the bulk adhesive layer 30 is a moisture curing adhesive.

In an aspect, the disclosure is directed to the polymeric layer 20 described herein disposed on a surface of the substrate 5. In some embodiments, the substrate 5 comprises a polymeric compound, calcium carbonate, a ceramic, a metal, concrete, stone, reef material or combinations thereof; and wherein the substrate is wet, dry, semi-wet or moist.

In some embodiments, the substrate 5 comprises a polymeric compound. In some embodiments, the substrate 5 comprises calcium carbonate. In some embodiments, the substrate 5 comprises a ceramic. In some embodiments, the substrate 5 comprises a metal. In some embodiments, the substrate 5 comprises concrete. In some embodiments, the substrate 5 comprises stone. In some embodiments, the substrate 5 comprises reef material. In some embodiments, the substrate 5 is a coral or a coral base. In some embodiments, the substrate 5 is limestone.

In some embodiments, the substrate has a smooth surface. In some embodiments, the substrate has a rough surface. In some embodiments, the substrate has an even surface. In some embodiments, the substrate has an uneven surface.

In some embodiments, the substrate 5 is wet. In some embodiments, the substrate 5 is dry. In some embodiments, the substrate 5 is semi-wet. In some embodiments, the substrate 5 is moist.

In some embodiments, the coral is dead. In some embodiments, the coral is alive. In some embodiments, the coral is psammocra or acropora coral. In some embodiments, the coral is psammocra coral. In some embodiments, the coral is acropora coral.

In some embodiments, a second substrate 50 is disposed on bulk adhesive layer 30. In some embodiments, the second substrate 50 is disposed on and in contact with bulk adhesive layer 30.

In some embodiments, the second substrate 50 comprises a polymeric compound, calcium carbonate, a ceramic, a metal, concrete, stone, reef material or combinations thereof; and wherein the substrate is wet, dry, semi-wet or moist.

In some embodiments, the second substrate 50 comprises a polymeric compound. In some embodiments, the second substrate 50 comprises calcium carbonate. In some embodiments, the second substrate 50 comprises a ceramic. In some embodiments, the second substrate 50 comprises a metal. In some embodiments, the second substrate 50 comprises concrete. In some embodiments, the second substrate 50 comprises stone. In some embodiments, the second substrate 50 comprises reef material. In some embodiments, the second substrate 50 is a coral, coral plug or a coral fragment. In some embodiments, the second substrate 50 is limestone.

In some embodiments, the second substrate has a smooth surface. In some embodiments, the second substrate has a rough surface. In some embodiments, the second substrate has an even surface. In some embodiments, the second substrate has an uneven surface.

In some embodiments, the second substrate 50 is wet. In some embodiments, the second substrate 50 is dry. In some embodiments, the second substrate 50 is semi-wet. In some embodiments, the second substrate 50 is moist.

In some embodiments, the coral is dead. In some embodiments, the coral is alive. In some embodiments, the coral is Psammocra or Acropora coral. In some embodiments, the coral is Psammocra coral. In some embodiments, the coral is Acropora coral.

In some embodiments, substrate 5 and second substrate 50 may optionally be coated with a sealant layer (not shown) disposed on a surface of substrate 5 or second substrate 50.

In an aspect, the disclosure is directed to methods of making a substrate comprising disposing the polymeric layer 20 described herein on a surface of the substrate 5. The methods of disposing the polymeric layer 20 described herein are not particularly limited and will be recognized by those skilled in the art.

In some embodiments, the methods of making a substrate comprise disposing the polymeric layer 20 on a substrate 5 by spin coating, dip coating, spray coating, ink jet printing, or the like. In some embodiments, the methods comprise disposing the polymeric layer 20 on a substrate 5 by spin coating. In some embodiments, the methods comprise disposing the polymeric layer 20 on a substrate 5 by dip coating. In some embodiments, the methods comprise disposing the polymeric layer 20 on a substrate 5 by spray coating. In some embodiments, the methods comprise disposing the polymeric layer 20 on a substrate 5 by ink jet printing.

In some embodiments, the methods of making a substrate comprise disposing the polymeric layer 20 on a substrate 5, wherein the polymeric layer 20 is applied to the substrate 5 as a solution. In some embodiments, the solution comprises from about 0.001% by weight to about 10% by weight of the catechol containing polymer or oligomer. In some embodiments, the solution comprises from about 0.01% by weight to about 5% by weight of the catechol containing polymer or oligomer. In some embodiments, the solution comprises from about 0.01% by weight to about 1% by weight of the catechol containing polymer or oligomer. In some embodiments, the solution comprises from about 0.1% by weight to about 1% by weight of the catechol containing polymer or oligomer.

In some embodiments, the solution comprises from about 0.001% by weight to about 0.005% by weight of the catechol containing polymer or oligomer; or from about 0.005% by weight to about 0.01% by weight of the catechol containing polymer or oligomer; or from about 0.01% by weight to about 0.02% by weight of the catechol containing polymer or oligomer; or from about 0.02% by weight to about 0.03% by weight of the catechol containing polymer or oligomer; or from about 0.03% by weight to about 0.04% by weight of the catechol containing polymer or oligomer; or from about 0.04% by weight to about 0.05% by weight of the catechol containing polymer or oligomer; or from about 0.05% by weight to about 0.06% by weight of the catechol containing polymer or oligomer; or from about 0.06% by weight to about 0.07% by weight of the catechol containing polymer or oligomer; or from about 0.07% by weight to about 0.08% by weight of the catechol containing polymer or oligomer 1; or from about 0.08% by weight to about 0.09% by weight of the catechol containing polymer or oligomer; or from about 0.09% by weight to about 0.1% by weight of the catechol containing polymer or oligomer; or from about 0.1% by weight to about 0.11% by weight of the catechol containing polymer or oligomer; or from about 0.11% by weight to about 0.12% by weight of the catechol containing polymer or oligomer; or from about 0.12% by weight to about 0.13% by weight of the catechol containing polymer or oligomer; or from about 0.13% by weight to about 0.14% by weight of the catechol containing polymer or oligomer; or from about 0.14% by weight to about 0.15% by weight of the catechol containing polymer or oligomer; or from about 0.15% by weight to about 0.2% by weight of the catechol containing polymer or oligomer; or from about 0.2% by weight to about 0.25% by weight of the catechol containing polymer or oligomer; or from about 0.25% by weight to about 0.3% by weight of the catechol containing polymer or oligomer; or from about 0.3% by weight to about 0.35% by weight of the catechol containing polymer or oligomer; or from about 0.35% by weight to about 0.4% by weight of the catechol containing polymer or oligomer; or from about 0.4% by weight to about 0.45% by weight of the catechol containing polymer or oligomer; or from about 0.45% by weight to about 0.5% by weight of the catechol containing polymer or oligomer; or from about 0.5% by weight to about 0.75% by weight of the catechol containing polymer or oligomer; or from about 0.75% by weight to about 1% by weight of the catechol containing polymer or oligomer; or from about 1.25% by weight to about 1.5% by weight of the catechol containing polymer or oligomer; or from about 1.5% by weight to about 1.75% by weight of the catechol containing polymer or oligomer; or from about 1.75% by weight to about 2% by weight of the catechol containing polymer or oligomer.

In some embodiments, the catechol containing polymer or oligomer used in the solution is poly-catechol styrene (PCS). In some embodiments, the solution comprises from about 0.001% by weight to about 10% by weight of PCS. In some embodiments, the solution comprises from about 0.01% by weight to about 5% by weight of PCS. In some embodiments, the solution comprises from about 0.01% by weight to about 1% by weight of PCS. In some embodiments, the solution comprises from about 0.1% by weight to about 1% by weight of PCS.

In some embodiments, the solution comprises from about 0.001% by weight to about 0.005% by weight of PCS; or from about 0.005% by weight to about 0.01% by weight of PCS; or from about 0.01% by weight to about 0.02% by weight of PCS; or from about 0.02% by weight to about 0.03% by weight of PCS; or from about 0.03% by weight to about 0.04% by weight of PCS; or from about 0.04% by weight to about 0.05% by weight of PCS; or from about 0.05% by weight to about 0.06% by weight of PCS; or from about 0.06% by weight to about 0.07% by weight of PCS; or from about 0.07% by weight to about 0.08% by weight of PCS; or from about 0.08% by weight to about 0.09% by weight of PCS; or from about 0.09% by weight to about 0.1% by weight of PCS; or from about 0.1% by weight to about 0.11% by weight of PCS; or from about 0.11% by weight to about 0.12% by weight of PCS; or from about 0.12% by weight to about 0.13% by weight of PCS; or from about 0.13% by weight to about 0.14% by weight of PCS; or from about 0.14% by weight to about 0.15% by weight of PCS; or from about 0.15% by weight to about 0.2% by weight of PCS; or from about 0.2% by weight to about 0.25% by weight of PCS; or from about 0.25% by weight to about 0.3% by weight of PCS; or from about 0.3% by weight to about 0.35% by weight of PCS; or from about 0.35% by weight to about 0.4% by weight of PCS; or from about 0.4% by weight to about 0.45% by weight of PCS; or from about 0.45% by weight to about 0.5% by weight of PCS; or from about 0.5% by weight to about 0.75% by weight of PCS; or from about 0.75% by weight to about 1% by weight of PCS; or from about 1.25% by weight to about 1.5% by weight of PCS; or from about 1.5% by weight to about 1.75% by weight of PCS; or from about 1.75% by weight to about 2% by weight of PCS.

In some embodiments, the solution also comprises an aqueous or organic solvent for dissolving the catechol containing polymer or oligomer. In some embodiments, the organic solvent is acetone, toluene or a combination thereof.

In some embodiments, the organic solvent is acetone. In some embodiments, the organic solvent is toluene. In some embodiments, the organic solvent is a combination of acetone and toluene. In some embodiments, the organic solvent is acetone and the catechol or catechol containing material is PCS. In some embodiments, the organic solvent is toluene and the catechol or catechol containing material is PCS. In some embodiments, the organic solvent is a combination of acetone and toluene and the catechol or catechol containing material is PCS.

The pH of the solution is not particularly limited. In some embodiments, the pH of the solution is about 3; or about 3.5; or about 4; or about 4.5; or about 5; or about 5.5; or about 6; or about 6.5; or about 7; or about 7.5; or about 8; or about 8.5; or about 9; or about 9.5; or about 10; or about 10.5; or about 11.

In some embodiments, the pH of the solution is from about 3-3.5; or about 3.5-4; or about 4-4.5; or about 4.5-5; or about 5-5.5; or about 5.5-6; or about 6-6.5; or about 6.5-7; or about 7-7.5; or about 7.5-8; or about 8-8.5; or about 8.5-9; or about 9-9.5; or about 9.5-10; or about 10- 10.5; or about 10.5-11.

In some embodiments, the methods of making a substrate comprise disposing the polymeric layer 20 on a substrate 5, wherein the substrate 5 comprises a polymeric compound, calcium carbonate, a ceramic, a metal, concrete, stone, reef material or combinations thereof; and wherein the substrate is wet, dry, semi-wet or moist.

In some embodiments, the methods of making a substrate 5 comprise disposing the polymeric layer 20 on a substrate 5 comprising a polymeric compound. In some embodiments, the methods comprise disposing the polymeric layer 20 on a substrate 5 comprising calcium carbonate. In some embodiments, the methods comprise disposing the polymeric layer 20 on a substrate 5 comprising a ceramic. In some embodiments, the methods comprise disposing the polymeric layer 20 on a substrate 5 comprising a metal. In some embodiments, the methods comprise disposing the polymeric layer 20 on a substrate 150 comprising concrete. In some embodiments, the methods comprise disposing the polymeric layer 20 on a substrate 5 comprising stone. In some embodiments, the methods comprise disposing the polymeric layer 20 on a substrate 5 comprising reef material.

In some embodiments, the methods of making a substrate comprise disposing the polymeric layer 20 on a wet substrate 5. In some embodiments, the methods comprise disposing the polymeric layer 20 on a dry substrate 5. In some embodiments, the methods comprise disposing the polymeric layer 20 on a semi-wet substrate 5. In some embodiments, the methods comprise disposing the polymeric layer 20 on a moist substrate 5.

In some embodiments, the methods of making a substrate comprise disposing the polymeric layer 20 on a substrate 5 in a dry environment. In some embodiments, the methods comprise disposing the polymeric layer 20 on a substrate 5 in an ambient environment. In some embodiments, the methods comprise disposing the polymeric layer 20 on a substrate 5 in a humid environment. In some embodiments, the methods comprise disposing the polymeric layer 20 on a substrate 5 in an aqueous environment. In some embodiments, the methods comprise disposing the polymeric layer 20 on a substrate 5 in an underwater environment. In some embodiments, the underwater environment is a salt-water environment. In some embodiments, the underwater environment is a fresh-water environment.

In some embodiments, the environment is in an aquatic tank setting, from small home tanks to the ones in display, for example, in museums. The present invention can operate in aqueous environments that have been subject to a chemical treatment, for example, chorine treatment of water for aquatic tanks. Similarly, hyperbaric environments, oxygen or nitrogen-bubble environments are also within the scope of the present invention. It should also be note that non-aqueous environment where the polymer is not likely to interact with the solution or the environment under which the adhesion is being performed is also within the scope of the present invention.

In some embodiments, the methods of making a substrate comprise disposing the polymeric layer 20 on a substrate 5 as a continuous layer. In some embodiments, the methods of making a substrate comprise disposing the polymeric layer 20 on a substrate 5 as a non-continuous layer. In some embodiments, the methods of making a substrate comprise disposing the polymeric layer 20 on a substrate 5 as a patterned layer or a textured layer.

In some embodiments, the methods of making a substrate comprise disposing the polymeric layer 20 on a substrate 5 by spin coating, dip coating, spray coating, ink jet printing, flood coating, brushing, wiping, or the like. In some embodiments, the methods comprise disposing the polymeric layer 20 on a substrate 5 by spin coating. In some embodiments, the methods comprise disposing the polymeric layer 20 on a substrate 5 by dip coating. In some embodiments, the methods comprise disposing the polymeric layer 20 on a substrate 5 by spray coating. In some embodiments, the methods comprise disposing the polymeric layer 20 on a substrate 5 by ink jet printing. In some embodiments, the methods comprise disposing the polymeric layer 20 on a substrate 5 by flood coating. In some embodiments, the methods comprise disposing the polymeric layer 20 on a substrate 5 by brushing. In some embodiments, the methods comprise disposing the polymeric layer 20 on a substrate 10 by wiping.

In an aspect, the disclosure is directed to methods of making a substrate comprising disposing the polymeric layer 20 described herein on a surface of the substrate 5, and further comprising disposing a bulk adhesive layer 30 on the polymeric layer 20. The methods of disposing the bulk adhesive layer 30 described herein are not particularly limited and will be recognized by those skilled in the art.

In some embodiments, the methods of making a substrate comprise disposing the bulk adhesive layer 30 on the polymeric layer 20 by spin coating, dip coating, spray coating, ink jet printing, flood coating, brushing, wiping, or the like. In some embodiments, the methods comprise disposing the bulk adhesive layer 30 on the polymeric layer 20 by spin coating. In some embodiments, the methods comprise disposing the bulk adhesive layer 30 on the polymeric layer 20 by dip coating. In some embodiments, the methods comprise disposing the bulk adhesive layer 30 on the polymeric layer 20 by spray coating. In some embodiments, the methods comprise disposing the bulk adhesive layer 30 on the polymeric layer 20 by ink jet printing. In some embodiments, the methods comprise disposing the bulk adhesive layer 30 on the polymeric layer 20 by flood coating. In some embodiments, the methods comprise disposing the bulk adhesive layer 30 on the polymeric layer 20 by brushing. In some embodiments, the methods comprise disposing the bulk adhesive layer 30 on the polymeric layer 20 by wiping.

In some embodiments, the methods of making a substrate comprise disposing the bulk adhesive layer 30 on the polymeric layer 20 in a dry environment. In some embodiments, the methods comprise disposing the bulk adhesive layer 30 on the polymeric layer 20 in an ambient environment. In some embodiments, the methods comprise disposing the bulk adhesive layer 30 on the polymeric layer in a humid environment. In some embodiments, the methods comprise disposing the bulk adhesive layer 30 on the polymeric layer 20 in an aqueous environment. In some embodiments, the methods comprise disposing the bulk adhesive layer 30 on the polymeric layer 20 in an underwater environment. In some embodiments, the underwater environment is a salt-water environment. In some embodiments, the underwater environment is a fresh-water environment.

In some embodiments, the methods of making a substrate comprise disposing the bulk adhesive layer 30 on the polymeric layer 20 on a substrate as a continuous layer. In some embodiments, the methods comprise disposing the bulk adhesive layer 30 on the polymeric layer 20 as a non-continuous layer. In some embodiments, the methods comprise disposing the bulk adhesive layer 30 on the polymeric layer 20 as a patterned layer or a textured layer.

In some embodiments, the methods for disposing the bulk adhesive layer 30 as a non-continuous layer or for disposing the polymeric layer 20 as a non-continuous layer comprise disposing the layers in an ordered pattern or a stochastic pattern.

In some embodiments, the ordered pattern comprises strips, a grid, concentric circles or a dot pattern. In some embodiments, the methods comprise disposing the bulk adhesive layer 30 and/or the polymeric layer 20 as strips. In some embodiments, the methods comprise disposing the bulk adhesive layer 30 and/or the polymeric layer 20 as a grid. In some embodiments, the methods comprise disposing the bulk adhesive layer 30 and/or the polymeric layer 20 as concentric circles. In some embodiments, the methods comprise disposing the bulk adhesive layer 30 and/or the polymeric layer 20 as a dot pattern.

In some embodiments, the methods comprise disposing the bulk adhesive layer 30 and/or the polymeric layer 20 stochastically.

The bulk adhesive layer 30 and/or the polymeric layer 20 can be disposed in particular shapes or in an amorphous manner. In some embodiments, the methods comprise disposing the bulk adhesive layer 30 and/or the polymeric layer 20 as a dot, a circle, a square, a rectangle, a pentagon, a hexagon; or as amorphous.

In an embodiment, the bulk adhesive layer 30 and/or the polymeric layer 20 are shaped as a dot. In an embodiment, the bulk adhesive layer 30 and/or the polymeric layer 20 are shaped as a circle. In an embodiment, the bulk adhesive layer 30 and/or the polymeric layer 20 are shaped as an oval. In an embodiment, the bulk adhesive layer 30 and/or the polymeric layer 20 are shaped as a triangle. In an embodiment, the bulk adhesive layer 30 and/or the polymeric layer 20 are shaped as a square. In an embodiment, the bulk adhesive layer 30 and/or the polymeric layer 20 are shaped as a rectangle. In an embodiment, the bulk adhesive layer 30 and/or the polymeric layer 20 are shaped as a pentagon. In an embodiment, the bulk adhesive layer 30 and/or the polymeric layer 20 are shaped as a hexagon. In an embodiment, the bulk adhesive layer 30 and/or the polymeric layer 20 are amorphous.

In some embodiments, the methods comprise disposing the bulk adhesive layer 30 and/or the polymeric layer 20 as gridlines, criss-cross lines, random lines, concentric circles, eccentric circles, spaghetti patterns and flat strips.

In some embodiments, the methods comprise disposing an optional sealant layer (not shown) on a surface of substrate 5 or second substrate 50.

In an embodiment, the bulk adhesive layer 30 and/or the polymeric layer 20 are shaped as gridlines. In an embodiment, the bulk adhesive layer 30 and/or the polymeric layer 20 are shaped as criss-cross lines. In an embodiment, the bulk adhesive layer 30 and/or the polymeric layer 20 are shaped as random lines. In an embodiment, the bulk adhesive layer 30 and/or the polymeric layer 20 are shaped as concentric circles. In an embodiment, the bulk adhesive layer 30 and/or the polymeric layer 20 are shaped as eccentric circles. In an embodiment, the bulk adhesive layer 30 and/or the polymeric layer 20 are shaped as a spaghetti pattern. In an embodiment, the bulk adhesive layer 30 and/or the polymeric layer 20 are shaped as a flat strip.

In an aspect, the disclosure is directed to a layered structure 100 comprising the polymeric layer 20 described herein. In some embodiments, layered structure 100 comprises multiple polymeric layers 20 described herein. In some embodiments, layered structure 100 comprises two polymeric layers 20 described herein. In some embodiments, layered structure 100 comprises three polymeric layers 20 described herein. In some embodiments, layered structure 100 comprises four polymeric layers 20 described herein. In some embodiments, layered structure 100 comprises five polymeric layers 20 described herein.

In an aspect, the disclosure is directed to a layered structure 100 comprising the polymeric layer 20 described herein disposed adjacent to and in contact with a bulk adhesive layer 30.

In some embodiments, layered structure 100 comprises multiple bulk adhesive layers 30 described herein. In some embodiments, layered structure 100 comprises two bulk adhesive layers 30 described herein. In some embodiments, layered structure 100 comprises three bulk adhesive layers 30 described herein. In some embodiments, layered structure 100 comprises four bulk adhesive layers 30 described herein. In some embodiments, layered structure 100 comprises five bulk adhesive layers 30 described herein.

In an aspect, the disclosure is directed to a layered structure 100 comprising the polymeric layer 20 described herein disposed on a substrate 5. In some embodiments, the substrate 5 comprises coral or a coral-like substance. In some embodiments, the substrate 5 comprises reef material or stone.

In an aspect, the disclosure is directed to a layered structure 100 comprising the polymeric layer 20 described herein disposed between a substrate 5 and a bulk adhesive layer 30. In an aspect, the disclosure is directed to a layered structure 100 comprising the polymeric layer 20 described herein disposed between a substrate 5 and a bulk adhesive layer 30, and further comprising a second substrate 50 disposed on the bulk adhesive layer 30. In some embodiments, the second substrate 50 comprises a coral, a coral plug or a coral fragment. In some embodiments, the second substrate 50 comprises a coral plug. In some embodiments, the second substrate 50 comprises a coral fragment.

In as aspect, the disclosure is directed to a layered structure 100 comprising polymeric layer 20 described herein disposed on substrate 5 and further comprising a bulk adhesive layer 30 disposed on the polymeric layer 20, a second polymeric layer 20 disposed on bulk adhesive layer 30; a tile or plug 10 disposed on the second polymeric layer 20; a third polymeric layer 20 described herein disposed on the tile or plug 10, a second bulk adhesive layer 30 disposed on the third polymeric layer 20, and a second substrate 50 disposed on the second bulk adhesive layer 30.

In an aspect, the disclosure is directed to an article comprising the polymeric layer 20 described herein. In some embodiments, the article comprises multiple polymeric layers 20 described herein. In some embodiments, the article comprises two polymeric layers 20 described herein. In some embodiments, the article comprises three polymeric layers 20 described herein. In some embodiments, the article comprises four polymeric layers 20 described herein. In some embodiments, the article comprises five polymeric layers 20 described herein.

In an aspect, the disclosure is directed to an article comprising the polymeric layer 20 described herein disposed adjacent to and in contact with a bulk adhesive layer 30.

In some embodiments, the article comprises multiple bulk adhesive layers 30 described herein. In some embodiments, the article comprises two bulk adhesive layers 30 described herein. In some embodiments, the article comprises three bulk adhesive layers 30 described herein. In some embodiments, the article comprises four bulk adhesive layers 30 described herein. In some embodiments, the article comprises five bulk adhesive layers 30 described herein.

In an aspect, the disclosure is directed to a method of bonding coral comprising disposing the polymeric layer 20 described herein between a substrate 5 and a second substrate 50.

In an aspect, the disclosure is directed to a method of repairing coral comprising disposing the polymeric layer 20 described herein between a substrate 5 and a second substrate 50.

In an aspect, the disclosure is directed to an article comprising the polymeric layer 20 described herein disposed on a substrate 5. In some embodiments, the substrate 5 comprises coral or a coral-like substance. In some embodiments, the substrate 5 comprises reef material or stone.

In an aspect, the disclosure is directed to an article comprising the polymeric layer 20 described herein disposed between a substrate 5 and a bulk adhesive layer 30. In an aspect, the disclosure is directed to an article comprising the polymeric layer 20 described herein disposed between a substrate 5 and a bulk adhesive layer 30, and further comprising a second substrate 50 disposed on the bulk adhesive layer 30. In some embodiments, the second substrate 50 comprises a coral, a coral plug or a coral fragment. In some embodiments, the second substrate 50 comprises a coral plug. In some embodiments, the second substrate 50 comprises a coral fragment.

In as aspect, the disclosure is directed to an article comprising polymeric layer 20 described herein disposed on substrate 5 and further comprising a bulk adhesive layer 30 disposed on the polymeric layer 20, a second polymeric layer 20 disposed on bulk adhesive layer 30; a tile or plug 10 disposed on the second polymeric layer 20; a third polymeric layer 20 described herein disposed on the tile or plug 10, a second bulk adhesive layer 30 disposed on the third polymeric layer 20, and a second substrate 50 disposed on the second bulk adhesive layer 30. In as aspect, the disclosure is directed to a repaired coral, wherein the coral adheres to a substrate or another coral piece via an adhesive system comprising the polymeric layer 20 described herein.

In as aspect, the disclosure is directed to a repaired coral, wherein the coral adheres to a substrate or another coral piece via an adhesive system comprising the polymeric layer 20 described herein and a bulk adhesive layer 30 disposed on and in contact with the polymeric layer 20.

The layered structure of FIG. 1 or FIG. 2 can be used for bonding coral or coral-like substances. Regarding FIG. 1, layered structure 100 can be assembled in a one-step process.

In an embodiment, a coral fragment (e.g., second substrate 50) can be bonded directly to coral (e.g., substrate 5) using a catechol containing polymer or oligomer (e.g., polymeric layer 20) and an MDI bulk adhesive (e.g., bulk adhesive layer 30).

In another embodiment, a coral fragment (e.g., second substrate 50) can be bonded directly to coral (e.g., substrate 5) using a catechol containing polymer or oligomer (e.g., polymeric layer 20) and a catechol containing bulk adhesive (e.g., bulk adhesive layer 30).

Regarding FIG. 2, layered structure 100 can be assembled in a two-step process.

In an embodiment, a coral fragment (e.g., second substrate 50) can be bonded to live coral (e.g., substrate 5) in a two-step process using an MDI bulk adhesive.

Step 1. Tile or plug 10 is coated with a catechol containing polymer or oligomer on the surfaces of opposing sides (e.g., a first and second polymeric layers 20). An MDI bulk adhesive (e.g., bulk adhesive layer 30) is applied to an outer surface of one of the first or second polymeric layers 20. A coral fragment (e.g., second substrate 50) is then set in the bulk adhesive layer 30. Such an arrangement is referred to as apparatus A. Apparatus A is subsequently submerged in water to allow for propagation over a period of time.

Step 2. After propagation, apparatus A is removed from the water and taken to a desired location for attachment to coral (e.g., substrate 5). Substrate 5 is coated with a catechol containing polymer or oligomer (e.g., third polymeric layer 20). An MDI bulk adhesive (e.g., bulk adhesive layer 30) is applied to the third polymeric layer 20. Apparatus A is then secured to substrate 5 via the second bulk adhesive layer 30 and third polymeric layer 20. In certain situations, the third polymeric layer 20 is optional and not included such that the second bulk adhesive layer 30 is applied directly to substrate 5.

In another embodiment, a coral fragment (e.g., second substrate 50) can be bonded to live coral (e.g., substrate 5) in a two-step process using a catechol containing bulk adhesive.

Step 1. Tile or plug 10 is coated with a catechol containing polymer or oligomer on the surfaces of opposing sides (e.g., a first and second polymeric layers 20). A catechol containing bulk adhesive (e.g., bulk adhesive layer 30) is applied to an outer surface of one of the first or second polymeric layers 20. In certain situations, the first and second polymeric layers 20 are optional and not included such that the bulk adhesive layer 30 is applied directly to tile or plug 10. A coral fragment (e.g., second substrate 50) is then set in the bulk adhesive layer 30. Such an arrangement is referred to as apparatus B. Apparatus B is subsequently submerged in water to allow for propagation over a period of time.

Step 2. After propagation, apparatus B is removed from the water and taken to a desired location for attachment to coral (e.g., substrate 5). Substrate 5 is coated with a catechol containing polymer or oligomer (e.g., third polymeric layer 20). A catechol containing bulk adhesive (e.g., second bulk adhesive layer 30) is applied to third polymeric layer 20. In certain situations, the third polymeric layer 20 is optional and not included such that the second bulk adhesive layer 30 is applied directly to substrate 5. Apparatus B is then secured to substrate 5 via the second bulk adhesive layer 30 and/or third polymeric layer 20.

The following Example is provided to illustrate some of the concepts described within this disclosure. While the Example is considered to provide an embodiment, it should not be considered to limit the more general embodiments described herein.

### EXAMPLES

### Example 1

### Baseline Performance of Commercial Adhesives

The goal of these experiments was to determine the baseline performance of commercially available adhesives to compare with experimental results.

Marble tiles were glued together using a variety of commercially available adhesives of different classes/chemistries. Tiles were glued both wet and dry. Adhesives used were JB Weld Epoxy®, Flex Glue®, Loctite Fast Grab 3x®, Gorilla Glue®, and Dowsil®.

It was observed that the Loctite Fast Grab 3x® seemed to give the best performance, displaying both initial grab and relatively strong curing after only about 15-30 minutes. The tiles with the Loctite Fast Grab 3x® could not be pulled apart by hand after several hours of curing in water.

### Example 2

### PCS Bond Strength on Dry Marble

The goal of these experiments was to determine the Lap Shear bond strength of PCS as a bulk adhesive on dry marble to compare with baseline of other commercial adhesives.

0.3 g of PCS (25% catechol) was diluted in 1 ml of acetone. The PCS solution was applied (0.2 ml) to one tile and then the second tile was placed on the adhesive. Overlap area was 1″ by ⅞″ giving a bonding surface area of 0.875 in sq.

It was observed that the catechol solution as a bulk adhesive (without fillers or cross-linking) did not have much tack or grab upon application.

### Example 3

### Optimization of PCS as a Bulk Adhesive on Limestone

The goal of these experiments was to determine the optimum formulation of PCS as a bulk adhesive on limestone in both dry and wet conditions and in conditions where the limestone includes a sealant and where the limestone does not include a sealant.

0.3 mg/ml of PCS solution was added to 100% chloroform with 25% CaCO₃. The solution was allowed to cure for 24 hours with no clamping. The PCS solution was applied (0.2 ml) to limestone tiles that included a sealant and to limestone tiles that did not include a sealant.

It was observed that the PCS solutions applied to dry limestone tile with and without sealant yielded cured systems that passed the 10 lb. test. It was observed that the PCS solutions applied to wet (underwater) limestone tile without sealant yielded cured systems that failed the 10 lb. test. It was observed that the PCS solutions applied to wet (underwater) limestone tile with sealant yielded cured systems that passed the 10 lb. test.

### Example 4

### Bond Strength of Adhesive and PCS on Wet Limestone

The goal of these experiments was to determine the lap shear bond strength of both PCS and Loctite 8x as bulk adhesives using both untreated and MDI sealed limestone in an underwater environment.

0.3 g of PCS (25% catechol) was diluted in 1 ml of solution (75% DMF/25% DCE). The PCS solution was applied (0.2 ml) to one tile and then the second tile was placed on the adhesive. Overlap area was 1″ by 7/8″ giving a bonding surface area of 0.875 in sq. 5 samples were prepared for the following variables: a) PCS adhesive w/untreated limestone; b) PCS adhesive w/MDI Treated limestone; c) Loctite 8x w/untreated limestone; and d) Loctite 8x with MDI treated limestone.

### Example 5

### Cure Testing of Adhesive and PCS on Wet Limestone

The goal of these experiments was to determine the grab time and cure time (evaluated as cure time needed to reach 10 PSI strength) of Loctite 8x and PCS bulk adhesive.

Samples were prepared as in Example 4 above. Using the Loctite 8x and PCS bulk adhesive in an underwater environment, multiple samples were prepared to evaluate time required to reach 10 PSI. The evaluation is carried out by hanging a 10 lb. weight off one end of bonded substrate.

It was observed that the average time to reach 10 PSI with the Loctite 8x was about 30 minutes. This was repeated for 5 samples. After 8 hours the PCS samples were still not able to meet the 10 lb. test. Approximate cure to 10 lbs. for PCS was between 8-24 hours.

### Example 6

### Monolayer PCS as Adhesive Primer

The goal of these experiments was to determine if a very thin layer (mono layer) of PCS as a primer could modify the surface chemistry of a substrate to improve overall performance of the bulk adhesive.

A PCS primer solution was prepared by adding 0.1 g per 100 ml of acetone (0.1% Primer Solution). This primer solution was then applied to various substrates such as steel, aluminum, and limestone using a pipet. The solution flashed off, leaving behind the PCS on the surface of the substrate. The adhesive Loctite 8x was then used on the primed surfaces to prepare standard lap shear samples.

It was observed that PCS has a large impact on improving the overall lab shear bond strength between substrates using the Loctite 8x adhesive. The results are summarized below in Table 1.

TABLE 1
Lap Shear Maximum Load (PSI)

| Substrate | Unprimed | PCS Primed | % Improvement |
|---|---|---|---|
| Aluminum | 74.5 | 502.2 | 574% |
| Steel | 383.5 | 613.4 | 60% |

### Example 7

### Coral Skeleton Testing

The goal of these experiments was to determine if PCS as a primer could improve coral adhesion.

Coral skeleton and several different types of frag plugs were commercially obtained from Something Fishy. The coral skeleton was pruned to create coral fragments. Each of the frag plugs was dipped in the PCS primer solution (0.1% PCS in Acetone). The frag plugs were in both pedestal (flat top) form and also forms that had an indentation for the placement of “stick” corals. Loctite 8x was used to adhere the coral frags to the plugs. All adhesion was performed underwater.

It was observed that the Loctite adhesive had significant grab to the PCS primed surface. Given the grab of the Loctite adhesive, the coral frags had very good initial adherence, while there was enough time to manipulate the frags if necessary. It was observed that within 30 minutes, one could pick up the entire apparatus (frag+plus) by holding only the fragment, showing that the bond was supporting the weight of the plug and the adhesive.

With some applied force (by fingers) the frag could be removed from the plug at 30 minutes.

Several of the plugs were adhered to untreated limestone tiles underwater in an attempt to simulate plantation of the plug to underwater rock. The plugs showed very strong adhesion, passing the 10 lb. test after 30 minutes. At full cure after 24 hours, the plugs could not be broken by hand from the limestone tiles. At full cure after 24 hours, the coral fragments required significant force to be removed by hand.

### Example 8

### Live Coral Test #1

The goal of these experiments was to determine if PCS as a primer could improve adhesion in live coral and ensure that the materials used would not harm the coral. These experiments were conducted under the guidance and supervision of coral expert Todd Kunkle.

A solution of PCS primer in Acetone (0.1% PCS) was prepared in a jar. Two flat coral plugs (concrete), four limestone tiles (with small indentations drilled into them), and 6 plugs with indentations (ceramic) were set aside to be used as bases for the coral fragment adhesion (for stick type corals).

The various coral fragment bases were submerged in the primer solution for 5 minutes to ensure proper coating and to allow all the solvent to evaporate. Coral fragments were prepared by cutting Acropora (7 samples) and Psammocora (15 samples). The coral fragments were removed from the water and adhered to the pre-primed bases using approximately 1 ml of Loctite adhesive dispensed from a 5 ml syringe.

To test immediate grab, the plug (with Coral attached) was placed in front of a submersible pump to test resistance to current. The current was varied between 1000 and 2500 gallons per hour. After all corals were mounted, two samples (one flat plug base and one limestone tile) were taken and mounted to a live rock to demonstrate adhesion between the base and plantation site. This activity was performed entirely underwater including dispensing of the adhesive. Following all the adhesion work, the mounted corals were placed in a tank for observation along with several snails and one fish.

It was first observed that the adhesive was easily dispensed from the syringe and readily bonded with the pre-primed bases. The corals also showed to have significant immediate grab. Immediately after bonding, the mounted corals were placed directly in front of a submergible pump. Without any curing time, it was observed that the corals could withstand a flow rate measuring at 1,000 gallons per hour without coming apart from the adhesive. Increasing the flow up to 2,500 gph, it was observed that approximately 50% of the samples would become dislodged. After 30 minutes of cure time, it was observed that all samples could withstand the maximum flow rate from the pump of 2,800 gallons per hour flowing directly over the area.

Following the coral mountings to the frag plugs, the flat coral plug and limestone tile were glued to the live rock. The adhesive in this case was dispensed from a caulk gun underwater. The adhesive was easily dispensed onto the primed surface of the plug and tile. The site of adhesion was not prepared and was uneven and porous, resulting in minimal surface area for boding. Nonetheless, it was observed that both the plug and tile had enough initial grab to withstand up to a 1,500 gph flow rate immediately. After 30 minutes of curing, it was observed that both the plug and tile could withstand the maximum flow rate of the pump of 2,800 gph.

After fully curing, several days later, both the plug and tile were removed by hand. It was observed that a failure occurred in the rock substrate, not in the adhesive bond.

Following a 24-hour curing period (full cure) the coral fragments were tested to determine the bond strength. Two of the 21 samples had poor adhesion and came right off and three other samples came off with some force by the fingers. The remaining samples were deemed to be secure (16/21). All the corals that failed were of the Psammocra variety. Most had very smooth and concave surfaces. All failures occurred between the adhesive and the coral body, not between the adhesive and the primed tiles.

Importantly, all but one of the coral fragments survived, as did the added snails and fish. Without wishing to be bound by any particular theory, it is believed the likely cause of death of the coral was due to mishandling as opposed to the adhesive materials.

### Example 9

### Live Coral Test #2

The goal of these experiments was to determine if the failure rate of 24% between the adhesive and the coral body of Example 8 could be reduced. Three measures were considered: 1) improved technique; 2) use of additional adhesive for concave shapes; and 3) applying a PCS primer directly to the coral.

Three separate priming/coating solutions for application to the frag plugs were applied (0.1% PCS(Acetone), 0.1% PS(Acetone/Toluene), 1% MDI(Acetone/Toluene). For the bases, 35 flat toped coral frag pedestals were used. Primer solutions were applied to the plugs using pipets and the solvent was allowed to evaporate. Coral fragments were prepared by cutting Acropora (7 samples) and Psammocora (28 samples). The coral fragments were removed from the water, some were directly primed using 0.1% PCS (10 samples) and 0.1% PS (5 samples), and then adhered to the pre-primed bases using approximately 1 ml of Loctite adhesive dispensed from a 5 ml syringe.

1. A polymeric layer comprising a catechol containing polymer or oligomer, wherein
said catechol presents as a catechol and/or as a semi-quinone and/or as a quinone without the presence of a primary amine or a secondary amine; wherein the polymeric layer optionally comprises a reactive material that is not reactive with catechol or quinone.

2. The polymeric layer of claim 1 further comprising a bulk adhesive layer disposed adjacent to and in contact with the polymeric layer; wherein the bulk adhesive layer is a moisture curing adhesive.

3. (canceled)

4. The polymeric layer of claim 1, wherein the polymeric layer comprises the reactive material and the reactive material is a urethane or a urethane component.

5. (canceled)

6. The polymeric layer of claim 1, wherein the polymeric layer has a thickness of from about 10 nanometers to about 100 microns; or a thickness of from about 15 nanometers to about 50 microns; or a thickness of from about 15 nanometers to about 15 microns; or a thickness of from about 150 nanometers to less than about 15 microns; or a thickness of from about 150 nanometers to about 1.5 microns.

7-11. (canceled)

12. The polymeric layer of claim 1, wherein the catechol containing polymer or oligomer comprises poly-catechol styrene (PCS) comprising from about 25% catechol to about 35% catechol.

13. The polymeric layer of claim 2, wherein the bulk adhesive layer comprises methylene diphenyl diisocyanate (MDI) resins or polycatechol styrene (PCS).

14. A substrate comprising the polymeric layer of claim 1 disposed on a surface of the substrate; wherein the substrate comprises a polymeric compound, calcium carbonate, a ceramic, a metal, concrete, stone, reef material or combinations thereof and
wherein the substrate is wet, dry, semi-wet or moist.

15. (canceled)

16. The substrate of claim 14, wherein the substrate comprises concrete, stone or reef material.

17-18. (canceled)

19. The substrate of claim 14, wherein the substrate is a coral or a coral base; or is limestone.

20-22. (canceled)

23. A second substrate in contact with the substrate of claim 14; wherein the second substrate is disposed on the polymeric layer and comprises a polymeric compound, calcium carbonate, a ceramic, a metal, concrete, stone, reef material or combinations thereof and
wherein the second substrate is wet, dry, semi-wet or moist.

24-25. (canceled)

26. The second substrate of claim 23, wherein the second substrate comprises calcium carbonate, concrete, stone or reef material.

27-29. (canceled)

30. The second substrate of claim 23, wherein the second substrate is limestone, a coral, a coral plug or a coral fragment.

31-33. (canceled)

34. The second substrate of claim 23, further comprising a second bulk adhesive layer disposed on the polymeric layer; wherein the second bulk adhesive layer comprises urethane or a urethane component.

35. (canceled)

36. A method of making a substrate comprising disposing the polymeric layer of claim 1 on a surface of the substrate; wherein the substrate comprises a polymeric compound, calcium carbonate, a ceramic, a metal, concrete, stone, reef material or combinations thereof.

37. (canceled)

38. The method of claim 36, wherein the substrate comprises calcium carbonate, stone or reef material.

39-40. (canceled)

41. The method of claim 36, wherein the substrate is limestone, a coral or a coral base.

42. (canceled)

43. The method of claim 36, wherein the disposing comprises disposing in a dry, ambient environment.

44. (canceled)

45. The method of claim 36, wherein the disposing comprises disposing in an aqueous environment.

46. The method of claim 45, wherein the aqueous environment is an underwater environment.

47. The method of claim 36, further comprising disposing a bulk adhesive layer on the polymeric layer; wherein the bulk adhesive layer comprises urethane or a urethane component.

48. (canceled)

49. The method of claim 36, further comprising disposing a second substrate on the substrate; wherein the second substrate comprises a polymeric compound, calcium carbonate, a ceramic, a metal, concrete, stone, reef material or combinations thereof and
wherein the second substrate is wet, dry, semi-wet or moist.

50. The method of claim 49, wherein the second substrate is disposed on the polymeric layer.

51. (canceled)

52. The method of claim 49, wherein the second substrate comprises calcium carbonate, concrete, stone or reef material.

53-55. (canceled)

56. The method of clam 49, wherein the second substrate is limestone, a coral, a coral plug or a coral fragment.

57-59. (canceled)

60. The method of claim 49, further comprising disposing a second bulk adhesive layer between the second substrate and the polymeric layer; wherein the second bulk adhesive layer comprises urethane or a urethane component.

61. (canceled)

62. A layered structure comprising the polymeric layer of claim 1 disposed between a first substrate and a second substrate.

63. An article comprising the polymeric layer of claim 1.

64. A method of bonding coral comprising disposing the polymeric layer of claim 1 between a first coral substrate and a second coral substrate.

65. A method of repairing coral comprising disposing the polymeric layer of claim 1 between a first coral substrate and a second coral substrate.
